(19) United States
(12) Patent Application Publication
(10) Pub. No.: US 2014/0137356 A1
(43) Pub. Date: May 22, 2014

(54) Device for Cleaning Photomask

(71) Applicant: GUDENG PRECISION INDUSTRIAL CO., LTD., New Taipei City (TW)

(72) Inventors: CHARNG-SHIUAN SUEN, New Taipei City (TW); YUNG-CHIN PAN, New Taipei City (TW)

(73) Assignee: GUDENG PRECISION INDUSTRIAL CO., LTD, New Taipei City (TW)

(21) Appl. No.: 13/770,942

(22) Filed: Feb. 19, 2013

(30) Foreign Application Priority Data
Nov. 21, 2012 (TW) 101222491

(51) Int. Cl. B08B 1/00

(52) U.S. Cl. CPC B08B 1/006
USPC 15/210.1

(57) ABSTRACT

The invention proposes a device for cleaning photomask comprising a wiping member wrapped on the surface of a central axle and unceasingly washed by cleaning fluid. When the photomask contacts the central axle, the washed wiping member can clean the photomask by rotation of the central axle in light of direction of the photomask's moving. After being wiped clean, the photomask will not be stained with dust or dirt.

### BACKGROUND OF THE INVENTION

1. Filed of the Invention

This present invention relates to a device for cleaning photomask, more particularly to a device having a wiping member for cleaning photomask.

2. Description of the Related Art

Photomask cleaners are used to clean photomasks to prevent subsequent integrated circuit manufacturing process from failing. The conventional photomask cleaners utilize wind knife, water jet or special cleaning fluid to clean photomasks wherein photomasks need additional blow-drying step when water jet or special cleaning fluid is used and further leaving water mark or water stain behind when photomasks are dried. In order to ameliorate the water mark or water stain defect, besides utilizing water jet or special cleaning fluid, improved photomask cleaners additionally apply a wiping method to clean photomasks; nevertheless, the cleaning process and the wiping method cannot work at the same time; as a result, it takes much time to proceed the two steps by turns; moreover, the cloth used for wiping is easily stained with dust or dirt on account of being frequently used, and the dust or dirt is likely to stain back on the photomask resulting in failure in subsequent integrated circuit manufacturing process.

### SUMMARY OF THE INVETNIION

For the purpose of solving the problems stated in the description of the related art, the present invention proposes a device for cleaning photomask and washing wiping member simultaneously.

The device for cleaning photomask comprises a base body, a central axle connected with the base body through two endpoints to form a straight line as an axle core for the central axle to rotate clockwise or counterclockwise, a wiping member wrapped on a surface of the central axle and a waterway system set inside the base body supplying cleaning fluid into the base body for unceasingly washing the wiping member and discharging the cleaning fluid from the base body. To clean the photomask, the photomask is put on the central axle to contact the wiping member. Suppose that direction the photomask moves is the same as direction the central axle rotates clockwise, afterward, movement of the photomask drives the central axle to rotate so that the washed wiping member can be rotated to contact the photomask. On the contrary, suppose that direction the photomask moves is different from direction the central axle rotates counterclockwise, afterward, the central axle is immovable and does not rotate as the photomask moves so that the washed wiping member rotated to contact the photomask can clean the moving photomask.

Cleaning the photomask and washing the wiping member at the same time is an advantage of the present invention. The present invention solves problems of frequently changing new wiping member and leaving water mark or water stain on the photomask, prevents subsequent integrated circuit manufacturing process from failing, reduces time for cleaning photomask and cost for changing wiping member and improves convenience and effectiveness of cleaning photomasks.

### BRIEF DESCRIPTION OF THE DRAWINGS

FIG. 1 illustrates a device for cleaning photomask.

FIG. 2 illustrates a sectional view of the device for cleaning photomask.

### DETAILED DESCRIPTION OF THE INVENTION

Hereinafter, embodiments of the invention will be explained in detail with reference to the drawings; however, the invention is not limited thereto.

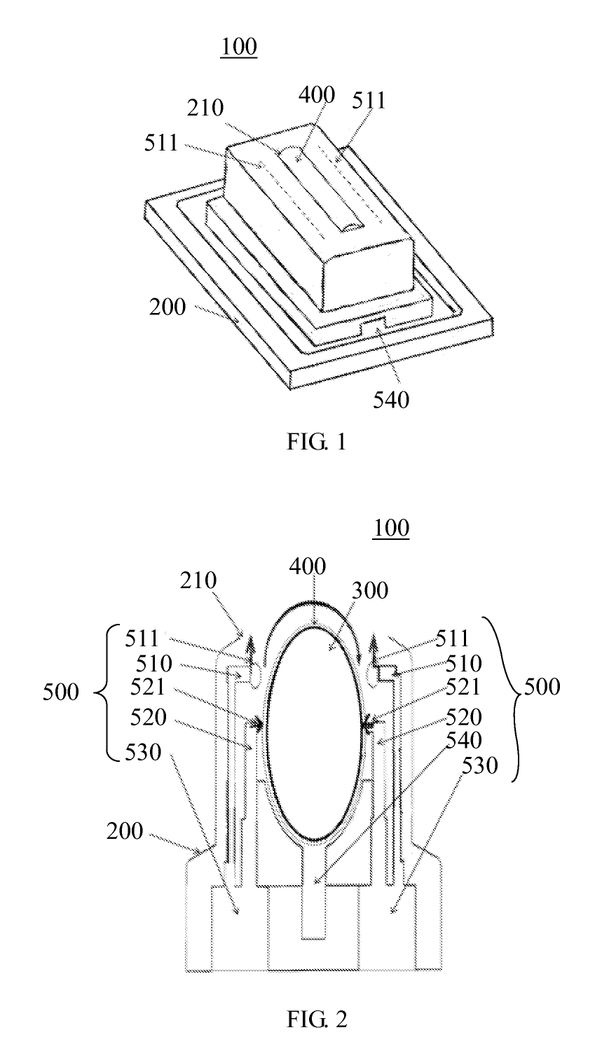

Refer to FIG. 1 and FIG. 2. FIG. 1 illustrates of a device for cleaning photomask 100. FIG. 2 illustrates of a sectional view of the device for cleaning photomask 100.

The device for cleaning photomask 100 comprises a base body 200 with an opening 210 and a central axle 300 connected with the base body 200 through two endpoints to form a straight line as an axle core for the central axle 300 to rotate clockwise or counterclockwise. A wiping member 400 which could be a fine particle-free, dust-free and fiber peeling-free material, for instance, a dust-free cloth, a dust-free paper or a sponge is flexibly wrapped or glued on a surface of the central axle 300 so that the wiping member 400 does not detach when partially contacting and cleaning the photomask.

The device for cleaning photomask 100 comprises a waterway system 500 set inside the base body 200 comprising at least one first waterway duct 510 with a first outlet orifice 511 facing upwards, at least one second waterway duct 520 with a second outlet orifice 521 facing the central axle 300, at least one outlet duct 530 and a discharge duct 540. The at least one first waterway duct 510 and the at least one second waterway duct 520 are set on both sides of the central axle 300 and both connected with the at least one outlet duct 530. Cleaning fluid which could be pure water or detergent is jetted from the at least one outlet duct 530 to the at least one first waterway duct 510 to moisten the photomask through the first outlet orifice 511 facing upwards and to the at least one second waterway duct 520 to continue spouting towards the central axle 300 through the second outlet orifice 521 to wash the wiping member 400. Superfluous cleaning fluid is quickly discharged through the discharge duct 540.

To clean the photomask, the photomask is put on the opening 210 of the base body 200 to contact the wiping member 400 and moves in a direction of left or right which is perpendicular to the axle core of the central axle 300. Suppose that direction the photomask moves rightward is the same as direction the central axle 300 rotates clockwise, afterward, movement of the photomask drives the central axle 300 to rotate so that the wiping member 400 washed by the second outlet orifice 521 can be moved to contact the photomask at the opening 210 by rotation of the central axle 300. On the contrary, suppose that direction the photomask moves leftward is the same as direction the central axle 300 rotates counterclockwise, afterward, the central axle 300 is immovable and does not rotate as the photomask moves so that the photomask can be effectively wiped clean by the wiping member 400 washed by the second outlet orifice 521 without leaving dirt, water mark or water stain behind

What is claimed is:

1. A device for cleaning photomask comprises:
a base body;
a central axle connected with the base body through two endpoints to form a straight line as an axle core for the central axle to rotate around;
a wiping member wrapped on a surface of the central axle; and
a waterway system set inside the base body supplying cleaning fluid into the base body and discharging the cleaning fluid from the base body.

2. The device for cleaning photomask as claimed in claim 1, wherein an opening set on the base body.

3. The device for cleaning photomask as claimed in claim 1, wherein the central axle rotates clockwise or counterclockwise.

4. The device for cleaning photomask as claimed in claim 1, wherein the wiping member is a dust-free cloth, a dust-free paper or a sponge.

5. The device for cleaning photomask as claimed in claim 1, wherein the waterway system comprises at least one first waterway duct and at least one second waterway duct set on both sides of the central axle, at least one outlet duct and a discharge duct set beneath the central axle.

6. The device for cleaning photomask as claimed in claim 5, wherein the at least one first waterway duct comprises a first outlet orifice facing upwards.

7. The device for cleaning photomask as claimed in claim 5, wherein the at least one second waterway duct comprises a second outlet orifice facing the central axle.

8. The device for cleaning photomask as claimed in claim 1, wherein the wiping member contacts and cleans a surface of the photomask of photomask's movement.

9. The device for cleaning photomask as claimed in claim 8, wherein direction of photomask's movement is the same as direction of the central axle's rotation, making the central axle rotate.

10. The device for cleaning photomask as claimed in claim 8, where direction of photomask's movement is different from direction of the central axle's rotation, making the central axle immovable.
